(19) United States
(12) Patent Application Publication
(10) Pub. No.: US 2010/0258642 A1
(43) Pub. Date: Oct. 14, 2010

(54) ENVIROMENTAL CONTROL SYSTEMS AND METHODS OF CONFIGURING ENVIRONMENTAL CONTROL SYSTEMS

(76) Inventors: Douglas A. Newcomer, New Market, MD (US); Bryan Levy, Annapolis, MD (US)

Correspondence Address: NIXON & VANDERHYE, PC, 901 NORTH GLEBE ROAD, 11TH FLOOR, ARLINGTON, VA, 22203, US

(21) Appl. No.: 12/821,485

(22) Filed: Jun. 23, 2010

Related U.S. Application Data
(63) Continuation-in-part of application No. 12/397,645, filed on Mar. 4, 2009.
(60) Provisional application No. 61/136,634, filed on Sep. 22, 2008.
(60) Provisional application No. 61/219,579, filed on Jun. 23, 2009.
(60) Provisional application No. 61/244,631, filed on Sep. 22, 2009.

(51) Int. Cl. F24F 7/00; B23P 19/04

(52) U.S. Cl. 236/49.5; 29/729

(57) ABSTRACT

An environmental control system of a building utilizes lower vents which open into lower portions of rooms of a building, and upper vents which open into upper portions of rooms of the building. When the system is operating in a heating mode, heated air is delivered into the upper portions of the rooms through the upper vents and air is removed from the rooms through the lower vents. When the system is operating in a cooling mode, cool air is delivered into the rooms through the lower vents, and air is removed from the rooms through the upper vents. Operating the heating and cooling modes in this fashion provides the most efficient operation of the heating and cooling system. A switching unit is used to selectively couple the inlet and outlet of an environmental control system to the upper and lower vents.

This application is a continuation-in-part of U.S. application Ser. No. 12/397,645, filed Mar. 4, 2009, which itself claims priority to U.S. Provisional Application No. 61/136,634, filed Sep. 22, 2008. This application also claims priority to the filing dates of U.S. Provisional Application No. 61/219,579, filed Jun. 23, 2009, and Provisional Application 61/244,631, filed Sep. 22, 2009. The contents of all of the foregoing applications are hereby incorporated herein be reference.

### FIELD OF THE TECHNOLOGY

The disclosed technology is related to heating and cooling systems used to heat and cool rooms of a building.

### BACKGROUND

Heating and cooling systems for buildings typically include a heating unit which produces heated air and a cooling unit which produces cool air. The hot or cool air is then delivered into rooms of a building through ducts and vents which open into the rooms. In addition, it is common to include air return vents and ducts which return air from one or more rooms of a building back to the heating unit or cooling unit. Thus, air is circulated from the heating and cooling unit, into the rooms, and then back to the heating and cooling unit.

The placement of the vents which deliver heated or cooled air into a room, and the placement of return vents which pull air back out of a room can vary depending on the building design. It is common to place such vents in the walls of a room, in the floor of a room, or in the ceiling of a room.

### BRIEF DESCRIPTION OF THE DRAWINGS

FIG. 1 is a diagram illustrating a heating and cooling system which is operating in a heating mode;

FIG. 2 is a diagram illustrating a heating and cooling system operating in a cooling mode;

FIGS. 3A and 3B are perspective views of a switching unit for a heating and cooling system configured in first and second operational modes, respectively;

FIGS. 4A and 4B are perspective views of another embodiment of a switching unit for a heating and cooling system configured in first and second operational modes, respectively;

FIG. 5 is a diagram of the placement of vents in the rooms of a building;

FIG. 6 is a diagram illustrating an alternate placement of vents within the rooms of a building;

FIG. 7 is a perspective view of a switching unit which includes multiple potential I/O ports configured in a first operational mode;

FIG. 8 is a perspective view of the switching unit in FIG. 7 configured in a second operational mode;

FIG. 9 is a perspective view of a switching unit which includes multiple input and output ports;

FIG. 10 is a front view of a switching unit which includes a motorized switching device;

FIG. 11 is a perspective view of a pyramid-shaped switching unit;

FIGS. 12A and 12B are top views of the pyramid-shaped switching unit of FIG. 11 with the switching plate in two different positions;

FIG. 13 is a diagram of a cylindrical-shaped switching unit coupled to a heating and cooling unit;

FIG. 14A is a perspective view of the core of the cylindrical-shaped switching unit of FIG. 13;

FIG. 14B is a front view of the cylindrical-shaped core of the switching unit of FIG. 14A;

FIG. 14C is a left side view of the cylindrical-shaped core of the switching unit of FIG. 14A;

FIGS. 15A and 15B illustrate an alternate embodiment of a switching unit;

FIGS. 16A and 16B illustrate yet another alternate embodiment of a switching unit;

FIG. 17 illustrates a heating and cooling unit that is capable of reversing the flow direction of air passing through the unit;

FIG. 18 illustrates an alternate embodiment of a heating and cooling unit that is capable of reversing the flow direction of air passing through the unit;

FIGS. 19A and 19B illustrate another alternate embodiment of a switching unit; and

FIG. 20 illustrates the elements of an environmental control system for a large building that incorporates a switching unit.

### DETAILED DESCRIPTION OF PREFERRED EMBODIMENTS

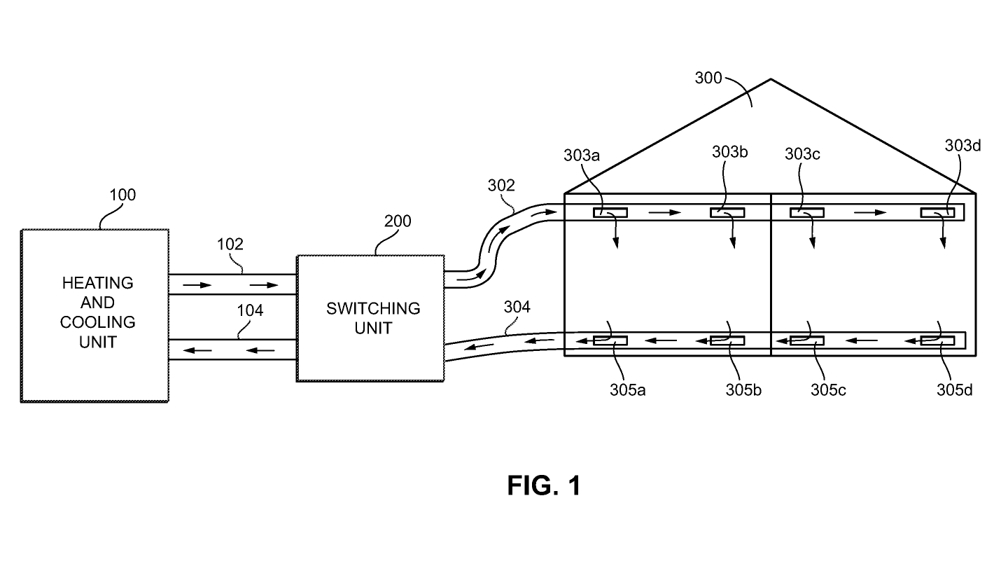

In a heating and cooling system embodying the invention, at least two vents are provided within a room of a building. An upper vent is positioned at an upper portion of the room, and a lower vent is positioned in a lower portion of the room. As shown in FIG. 1, the heating and cooling system would include a heating and cooling unit 100 which is connected to a switching unit 200.

The heating and cooling unit could take numerous different forms. It could be a traditional gas or electric furnace, paired with a traditional air conditioning unit. In other instances, it could be a heat pump. In other instances, it could take other forms. Regardless of the actual form of the device, it would be capable of delivering both heated air for heating rooms of a building, and cooled air for cooling rooms of a building. While certain sections of the following description refer to a heating and cooling unit, this term is meant to refer to any device or devices capable of delivering heated and/or cooled air.

The switching unit 200 would be connected to a first duct 302 which is connected to the upper vents that open into upper portions of the rooms of a building. The switching unit would also be connected to a lower duct 304 which is connected to lower vents 305a, 305b, 305c, 305d which open into lower portions of the rooms of a building 300.

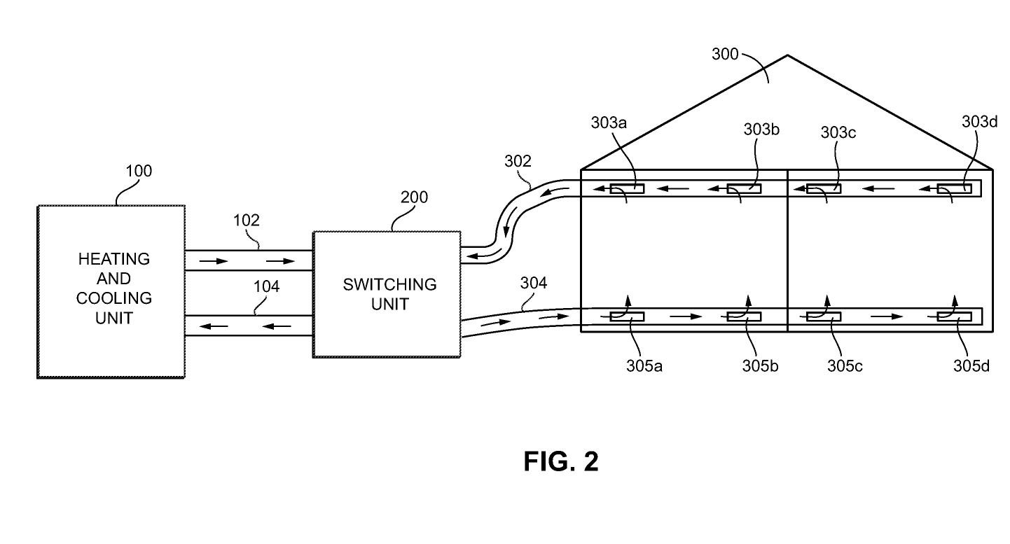

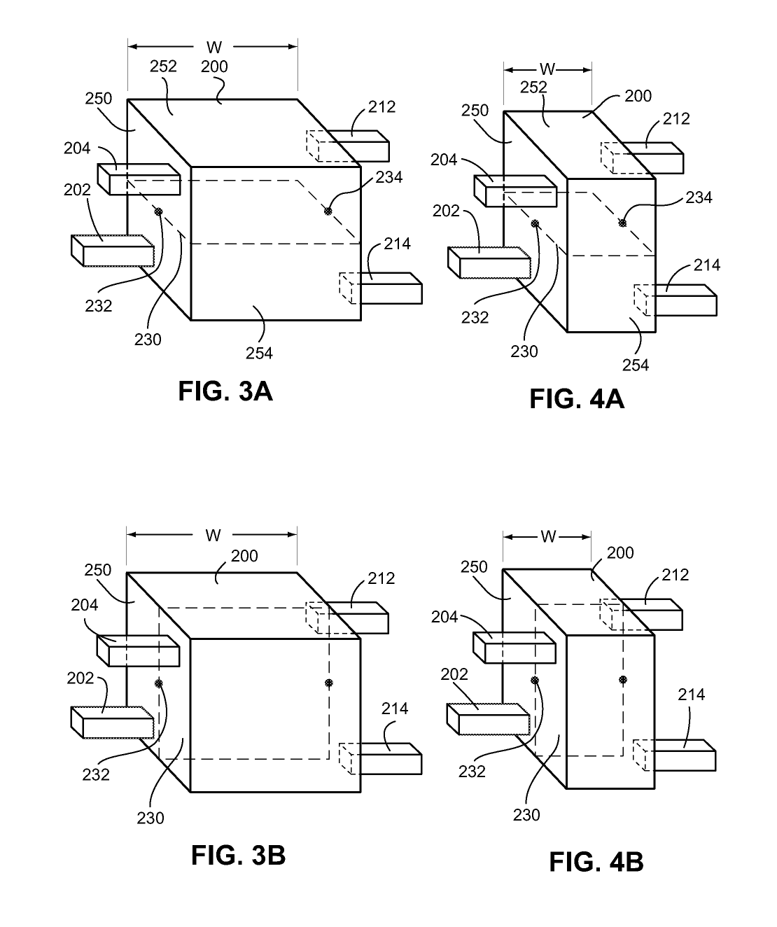

FIGS. 3A and 3B illustrate one embodiment of a switching unit 200 which can be used in the heating and cooling system illustrated in FIGS. 1 and 2. As shown in FIG. 3A, the switching unit 200 includes an input port 204 which is attached to the upper right side of a front wall 250 of the switching unit 200. In addition, an output port 202 is provided in a lower left side of the front wall 250.

A first input/output (I/O) port 212 is provided on a rear face of the switching unit. In addition, a second I/O port 214 is also provided on the rear face of the switching unit. Note, the first I/O port 212 is located on the upper right side of the rear face of the switching unit, and the second I/O port 214 is provided on the lower left side of the rear face of the switching unit.

A rectangular switching plate 230 is rotatably mounted inside the switching unit 200. In the embodiment shown in FIG. 3A, the switching plate 230 is mounted on two pivot points 232, 234 located on the front and rear faces of the switching unit. This allows the switching plate to rotate between a horizontal position, as shown in FIG. 3A, and a vertical position, as shown in FIG. 3B.

When the switching plate 230 is located in the horizontal position, as shown in FIG. 3A, air entering the switching unit 200 through the input port 204 can be communicated to the first I/O port 212. Air entering the switching unit through the second I/O port 214 can be communicated to the output port 202.

When the switching plate 230 is rotated to the vertical position, as shown in FIG. 3B, the connections are changed. As shown in FIG. 3A, when the switching plate is oriented vertically, the air entering the input port 204 will be communicated to the second I/O port 214. Likewise, air entering the switching unit through the first I/O port 212 will be communicated to the output port 202.

The ability to change how the input port 204 and output port 202 of the switching unit are coupled to the two I/O ports 212, 214 makes it possible to change how heated and cooled air is delivered to and removed from the rooms of a building. This capability also makes it possible to increase the efficiency of a typical heating and cooling system of a building.

FIGS. 4A and 4B show another embodiment of a switching unit 200 in first and second operational conditions. As is apparent, the width of the second embodiment is approximately half the width of the embodiment illustrated in FIGS. 3A and 3B. The width of this type of a switching unit can be changed to suit the area in which the switching unit is to be mounted. It may be necessary, in some situations, to reduce the width of the switching unit to accommodate the available mounting space.

FIG. 1 illustrates the heating and cooling system when it is operating in a heating mode. In other words, FIG. 1 shows the system when heated air is being delivered into the rooms of the building 300. As shown in FIG. 1, heated air from the heating and cooling unit 100 is delivered to an input port of the switching unit 200. The heated air is then communicated to an upper duct 302 which is connected to upper vents 303a, 303b, 303c, 303d located in the upper portions of the rooms of the building 300.

If the switching unit shown in FIGS. 3 and 4 were used in the heating and cooling systems shown in FIGS. 1 and 2, the output of the heating and cooling unit 100 would be connected to the input port 204 of the switching unit 200. Likewise, the output port 202 of the switching unit would be coupled to the input of the heating and cooling unit 100. The upper duct 302 would be coupled to the first I/O port 212, and the lower duct 304 would be coupled to the second I/O port 214.

When the system is operating in the heating mode, as illustrated in FIG. 1, the switching plate would be oriented horizontally, as shown in FIG. 3. As a result, the heated air delivered from the heating and air conditioning unit 100 to the input port 204 of the switching unit 200 would be communicated to the upper duct 302, which is coupled to the first I/O port 212. The heated air would be delivered to the upper portions of the rooms of the building via the upper vents 303a, 303b, 303c and 303d.

In addition, air would also be simultaneously removed through the lower vents 305a, 305b, 305c, 305d of the rooms of the building. The air removed from the rooms would be communicated through the lower duct 304 which is attached to the second I/O port 214 of the switching unit 200 shown in FIG. 3. The air removed from the rooms of the building would then exit the switching unit 200 through the output port 202, and the air would be communicated through an output duct 104 back to the heating and cooling unit 100. The air returned to the heating and air conditioning unit 100 through the output duct 104 would then be heated and sent back to the switching unit 200 through duct 102.

FIG. 2 illustrates the same system operating in a cooling mode. In the cooling mode, the heating and cooling unit 100 would be supplying cooled air to the switching unit 200 through the duct 102. The switching unit would be configured as shown in FIG. 4, where the switching plate 230 is oriented vertically. As a result, the cooled air delivered into the input port 204 of the switching unit 200 would be delivered to the second I/O port 214. The second I/O port 214, which is connected to the lower duct 304, would ensure that the cooled air is then delivered to the lower portions of the rooms of the building 300 through the lower vents 305a, 305b, 305c, 305d.

At the same time, air would be removed from the rooms of the building through the upper vents 303a, 303b, 303c, 303d. The air removed from the upper portions of the rooms would travel along the upper duct 302 to the first I/O port 212 of the switching unit 200. Because the switching plate 230 is oriented vertically, as shown in FIG. 4, the air removed from the rooms of the building entering the switching unit 200 through the first I/O port 212 would then be communicated to the output port 202 of the switching unit 200. The air removed from the rooms of the building would then be sent through the duct 104 back to the heating and cooling unit 100. The air received back from the rooms of the building would then be cooled and sent back to the switching unit 200 through the duct 102.

When a heating and cooling system is configured as illustrated in FIGS. 1 and 2, it is possible to operate the system in two different modes. In the heating mode, as shown in FIG. 1, the heated air is delivered to the upper portions of the rooms through the upper vents, and air is removed from the rooms through the lower vents. Conversely, when the system is operating in a cooling mode, as shown in FIG. 2, cooled air is delivered to the lower portions of the rooms through the lower vents, and air is removed from the rooms through the upper vents.

The coolest air within the rooms would be located in the lower portions of the rooms. As a result, when the heating and cooling system is operating in the heating mode, the coolest air within the rooms will be sucked into the lower vents and returned back to the heating and air conditioning unit so that it can be reheated. The flow pattern within the room would be from the top to the bottom of the room. And because the warmer air would normally be located at the upper portions of the room, this air flow pattern will help to better distribute the heated air down to the lower portions of the room.

Conversely, when the system is operating in the cooling mode, as shown in FIG. 2, the cooled air is first delivered to the lower portions of the room, and air is removed from the upper portions of the room. Again, the warmest air within the room will be located in the upper portions of the room. By removing the warmer air from the upper portions of the room, the warmest air in the room will be removed first. In addition, the flow pattern for the air within the room will be from the bottom to the top. This helps to distribute the relatively cooler air from the bottom of the room into the upper portions of the room.

It is believed by the inventor that operating the heating and cooling system in these two different heating and cooling modes will result in the most efficient heating and cooling of the rooms of the building. Operating in this fashion will also ensure that in the heating mode, heated air is redistributed to the coolest portions of the room in a more effective fashion, and in the cooling mode, cooled air will be redistributed to the warmest portions of the room in the most efficient fashion.

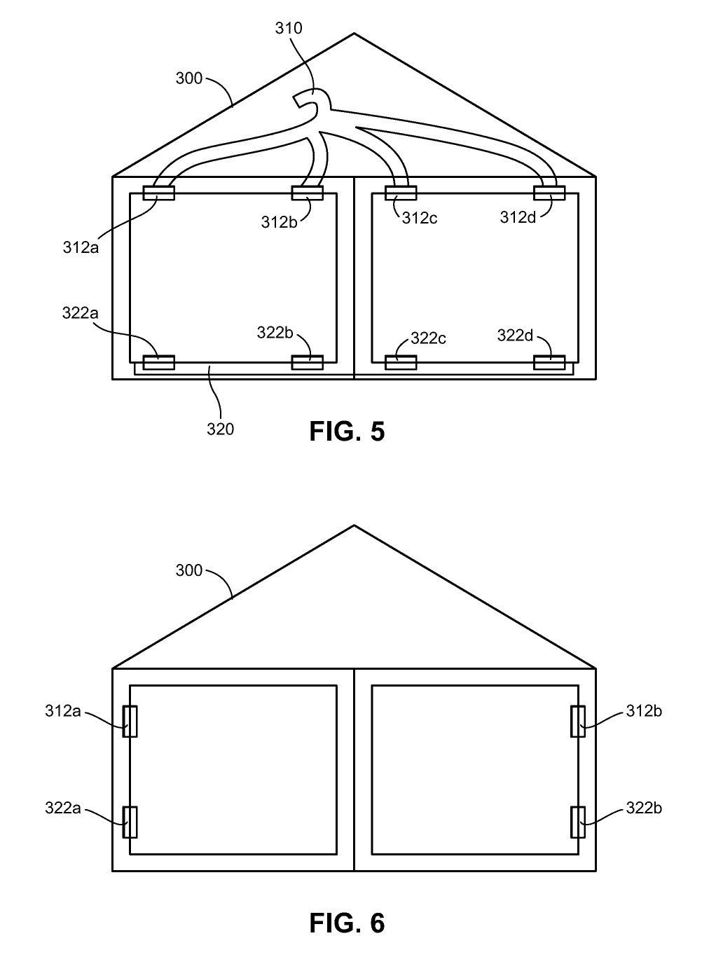

The actual locations of the upper and lower vents can vary from one installation to another. As shown in FIG. 5, in some instances the lower vents 322a, 322b, 322c, 322d can be located within the floor of the rooms of the building 300. The lower ducts may be coupled to a lower duct 320 running underneath the floor of the building. Likewise, the upper vents 312a, 312b, 312c, 312d could be located within the ceiling of the building. The upper vents could be attached to an upper duct 310 which runs through the ceiling or possibly in the attic of the building.

In alternate instances, as shown in FIG. 6, the upper vents 312a, 312b could be located in walls of the rooms. Likewise, the lower vents 322a, 322b could also be located within the walls of the rooms. In still other instances, the upper vents could be located in a ceiling, while the lower vents are located in either the walls or the floor of a room. Likewise, the lower vents could be located in the floor, whereas the upper vents are located in the walls of the rooms.

The actual locations of the upper and lower vents is somewhat unimportant so long as the lower vents are located in a lower portion of a room, and the upper vents are located in an upper portion of a room.

In the switching unit illustrated in FIGS. 3 and 4, the input port 204 and output port 202 are formed on a front wall of the switching unit, whereas the first I/O port 212 and the second I/O port 214 are located on an opposite rear wall of the switching unit. In alternate embodiments, it would be possible to move the first and second I/O ports and/or the input port and output port to different locations.

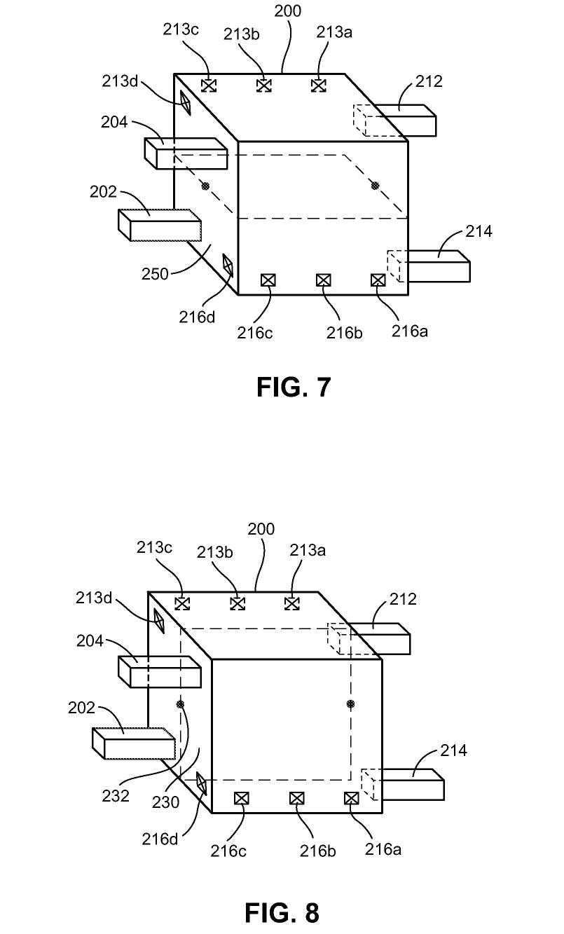

FIGS. 7 and 8 illustrate a switching unit which is similar to the one shown in FIGS. 3 and 4. In FIGS. 7 and 8, the input port 204 and the output port 202 are still located on a front wall 250 of the switching unit. However, FIGS. 7 and 8 illustrate a plurality of alternate locations for the first I/O port and the second I/O port. As shown therein, the first I/O port 212 could also be located at the positions identified with reference numerals 213a, 213b, 213c, and 213d. Likewise, the second I/O port 214 could be located at the alternate locations identified with reference numerals 216a, 216b, 216c, and 216d.

FIG. 7 depicts the switching unit 200 where the switching plate 230 is oriented horizontally. As a result, the input port 204 will deliver air to the first I/O port 212. However, if the first I/O port 212 were moved to one of the alternate locations 213a, 213b, 213c and 213d, air entering through the input port 204 would be delivered to the first I/O port at any of these alternate locations.

Air entering the switching unit through the second I/O port 214 would be communicated to the output port 202. And if the second I/O port 214 were moved to one of the alternate locates 216a, 216b, 216c, 216d, the air entering the switching unit through any of these alternate locations would still be communicated to the output port 202.

FIG. 8 shows the switching unit after the switching plate 230 has been oriented to a vertical position. As a result, air entering the switching unit 200 through the input port 204 would be communicated to the second I/O port 214, or to any of the alternate locations 216a, 216b, 216c, 216d. Likewise, air entering the switching unit through the first I/O port 212 would be communicated to the output port 202 regardless of whether it enters through the rear face of the switching unit or through one of the alternate locations 213a, 213b, 213c, 213d.

FIGS. 7 and 8 illustrate that the first and second I/O ports can be moved to different locations on the switching unit 200 while still preserving the same basic functionality of the sidewalls switching unit. The first and second I/O ports could also be moved to selected locations on the top and bottom surfaces. However, the input port 204 and the output port 202 can also be moved to different locations on the switching unit without altering the basic functionality of the switching unit.

Depending on where the switching unit is installed in a building, and depending upon the ducting arrangement required for the installation, it may be advantageous to attach the first and second I/O ports to one of the alternate locations on the switching unit. Likewise, it may be advantageous to move the input port and the output port to an alternate location. Moving the first and second I/O ports and/or the input port and output port to an alternate location might result in a small decrease in the efficiency of the switching unit, due to air flow losses. However, locating one of the I/O ports or the input port or output port at an alternate location may be necessary to accommodate the particular arrangement within the building.

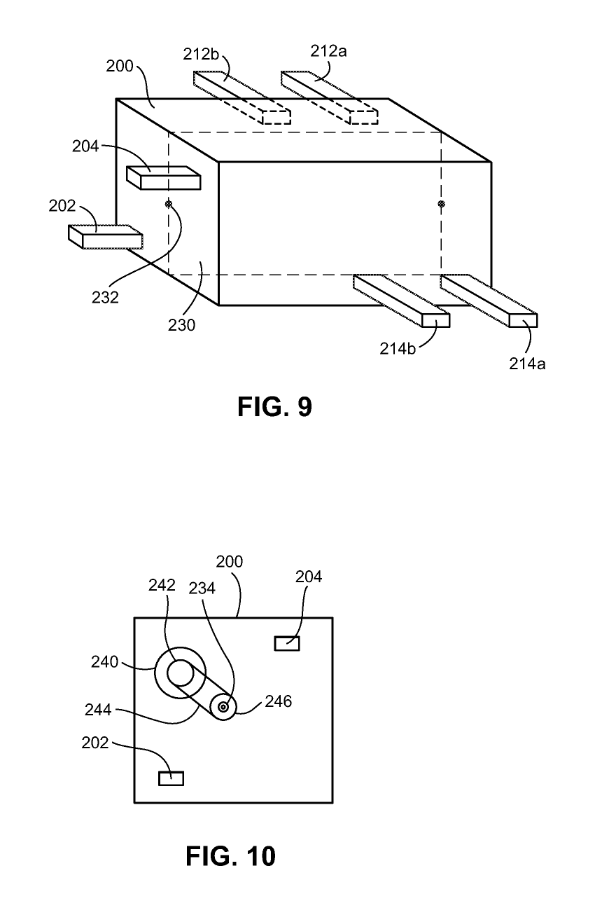

In addition, in the embodiments shown in FIGS. 3, 4, 7 and 8, only a single duct is shown attached to the first I/O port, and only a single duct is attached to the second I/O port. In alternate embodiments, as shown in FIG. 9, a plurality of ducts may act as I/O ports. In the embodiment shown in FIG. 9, the first I/O port has been replaced with two first I/O ports 212a, 212b located on a side face of the switching unit (the alternate locations). Likewise, the second I/O port 214 has been replaced with two second I/O ports 214a, 214b located on another side face of the switching unit (the alternate locations).

Similarly, the embodiments shown in FIGS. 1-4, 7 and 8, show only a single duct attached to the input port 204, and only a single duct attached to the output port 202. In alternate embodiments, multiple ducts could deliver heated and cooled air from the heating and cooling unit 100 to the switching unit 200, and the multiple ducts could be attached to switching unit at multiple locations. Likewise, multiple ducts could deliver air returning from the rooms from the switching unit 200 to the heating and cooling unit, and the multiple ducts could be attached to switching unit at multiple locations. Further, in some embodiments, multiple ducts might deliver heated and cooled air from the heating and cooling unit to the switching unit, while only a single duct delivers return air from the switching unit to the heating and cooling unit, and vice versa.

As noted above, the rectangular or square switching plate 230 within the switching unit is rotatably mounted on two pivot points 232, 234. In some embodiments, the user might manually rotate the switching plate 203 between the horizontal and vertical orientations using a lever or knob attached to the switching plate in order to switch the system from the heating to the cooling mode, or vice versa. Some type of locking system could also be provided to lock the switching plate in either the horizontal or vertical position.

In other embodiments, a power device could be used to move the switching plate 230 between the horizontal and vertical orientations. FIG. 10 illustrates an embodiment in which an electric motor 240 is coupled to a drive belt 244 via a pulley 242. The drive belt 244 is also attached around a pulley 246 which is attached to a rotational axis of the switching plate 230. As a result, rotation of the motor 240 will cause the switching plate 230 to rotate between the horizontal and vertical orientations.

Note, in some embodiments, the switching plate 230 could be moved 90 degrees clockwise, and then 90 degrees counterclockwise to switch the switching plate 230 back and forth between the horizontal and vertical orientations. In other embodiments, the switching plate could simply be rotated clockwise 90 degrees at a time to move the switching plate between the vertical and horizontal orientations.

In alternate embodiments, a different type of powered switching means could be used to cause the switching plate to move between the vertical and horizontal orientations. The motor illustrated in FIG. 10 is only one non-limiting embodiment. For instance, the switching unit could be a rack and pinion arrangement, a hydraulically or pneumatically operated piston arrangement, a linear motor arrangement, or any other type of device which can be used to impart rotational motion, as is well known to those skilled in the art.

Moreover, the switching units illustrated in FIGS. 3, 4 and 7-10 are all rectilinear units having square or rectangular switching plates. In alternate embodiments, the switching unit could take on a variety of other forms. Regardless of the specific form of the switching unit, however, the switching unit should preferably be capable of switching the heated and cooled air output by a heating and cooling unit between the upper vents in a room and the lower vents in a room.

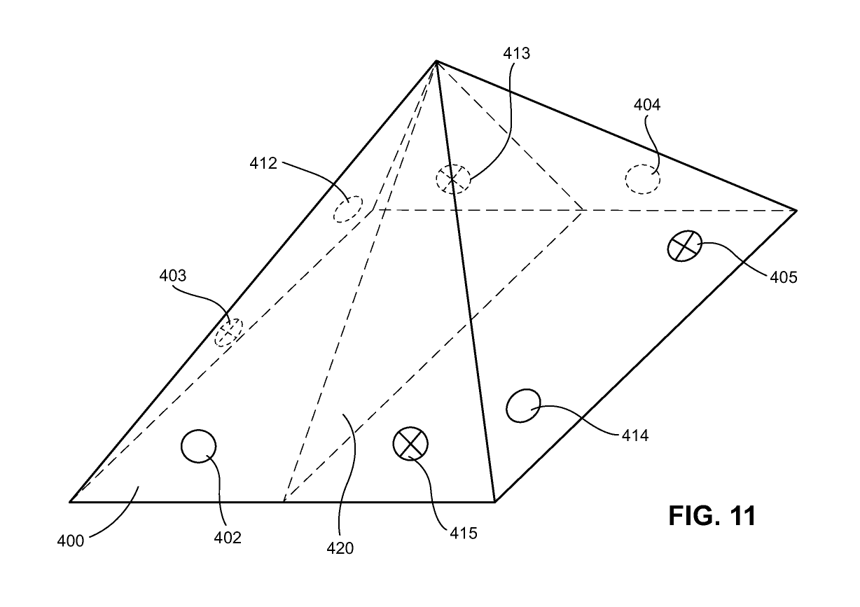

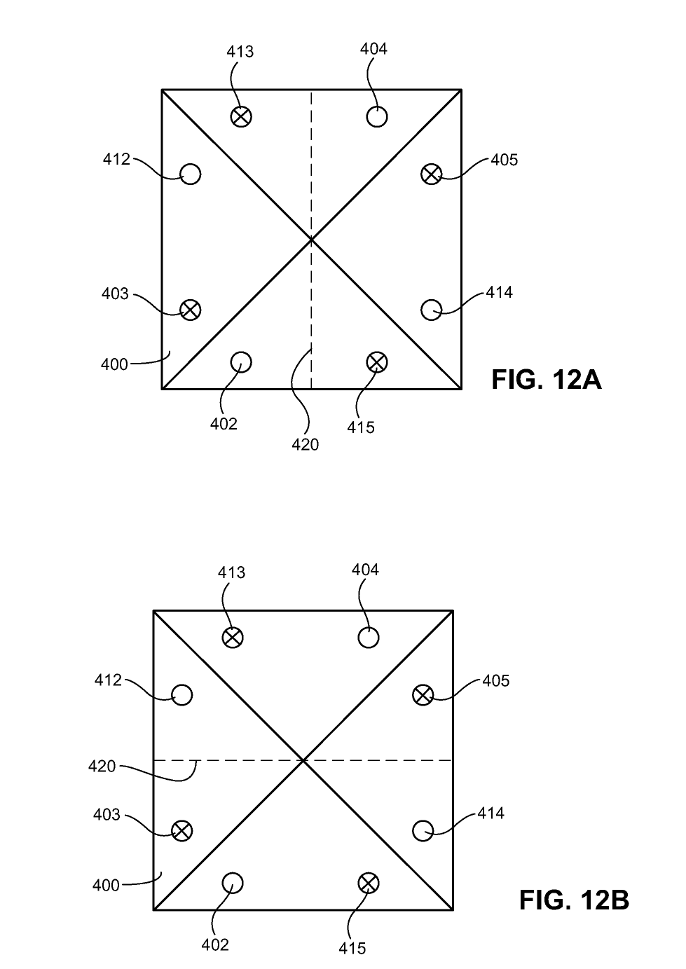

FIG. 11 is a perspective view of a pyramid-shaped switching unit which could also be used in a system embodying the invention. As illustrated in FIG. 11, a triangular-shaped switching plate 420 is rotationally mounted within the triangular-switching unit 400. FIGS. 12a and 12b illustrate a top view of the triangular-shaped switching unit 400 shown in FIG. 11. In FIG. 12a, the switching plate 420 is oriented in a first position. In FIG. 12b, the switching plate 420 has been rotated 90 degrees so that it is oriented in the second position.

The triangular-shaped switching unit includes an input port 402, and an output port 404. In addition, the triangular-shaped switching unit includes a first I/O port 412 and a second I/O port 414.

When the triangular-shaped switching plate 420 is oriented as shown in FIG. 12a, heated or cooled air entering in an interior of the switching unit through the input port 402 would be communicated to the first I/O port 412. Likewise, air returning from rooms of a building entering the switching unit through the second I/O port 414 would be communicated to the output port 404.

When the switching plate 420 is rotated to the position shown in FIG. 12b, the input port 402 would be connected to the second I/O port 414. Also, the first I/O port 412 would be connected to the output port 404.

As also illustrated in FIGS. 11, 12a and 12b, the input port, output port and first and second I/O ports could be located at alternate locations. For instance, the input port 402 could also be located at the position marked with reference numeral 403. The output port 404 could also be located at the alternate position identified with reference numeral 405. The first I/O port 412 could be located at the alternate position 413. Further, the second I/O port 414 could be located at the alternate position 415.

Furthermore, as explained above, two input ports could be provided at locations 402 and 403, and two output ports could be located at positions 404 and 405. Likewise, two first I/O ports could be located at positions 412 and 413, and two second I/O ports could be located at positions 414 and 415.

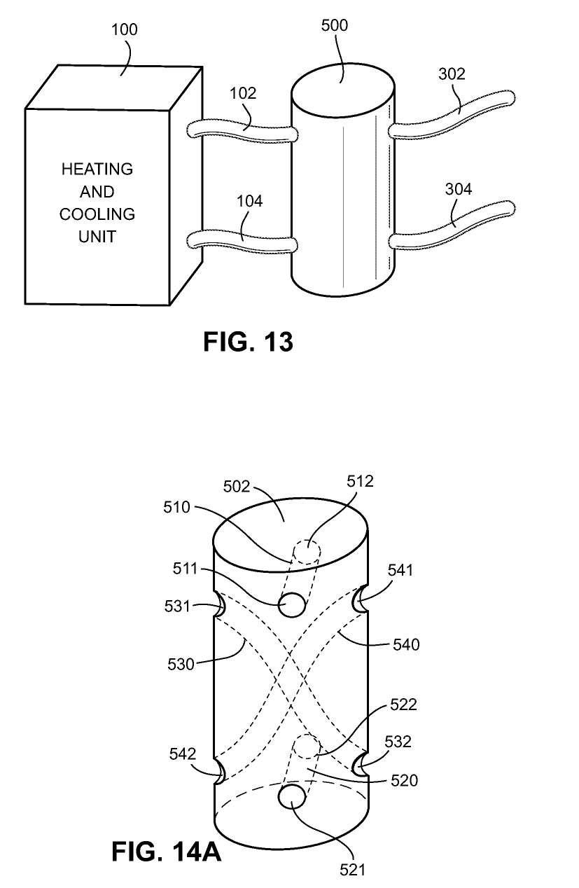

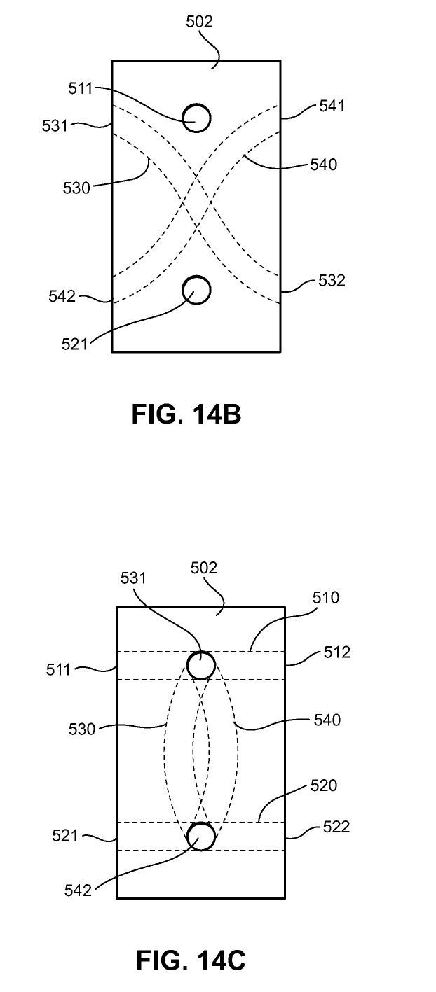

FIG. 13 illustrates the use of a cylindrical-shaped switching unit in a heating and cooling system embodying the invention. The cylindrical switching unit 500 has a cylindrical shaped core 502, as illustrated in FIG. 14A, mounted inside a cylindrical outer shell. The cylindrical core 502 is rotated 90 degrees inside the outer shell to change how the output vent 102 and input vent 104 are coupled to an upper duct 302 and a lower duct 304.

FIG. 14a shows a perspective view of the core 502 of the cylindrical switching unit 500 illustrated in FIG. 13. As shown in FIG. 14a, the cylindrical core 502 includes an upper horizontal duct 510 passing between two upper horizontal ports 511, 512. The core also includes a lower horizontal duct 520 passing between two lower horizontal ports 521, 522. When the core 502 is rotated so that the upper horizontal port 511 is connected to the output duct 102, the opposite upper horizontal port 512 would be connected to the upper duct 302. Further, the lower horizontal port 521 would be connected to the duct 104, and the opposite lower horizontal port 522 would be connected to the lower duct 304.

When the core 502 of the switching unit is rotated 90 degrees, the upper and lower horizontal ducts 510, 520 would no longer be in registration with the upper duct 302, lower duct 304, or the ducts 102 and 104 passing to the heating and cooling unit 100. Instead, a first vertical duct 530 would connect the output duct 102 to the lower duct 304 passing to the building. Also, the second vertical duct 540 would connect the upper duct 302 from the building to the input duct 104 passing into the heating and cooling unit.

FIG. 14B presents a front view of the core 502 of the cylindrical-shaped switching unit, and FIG. 14C presents a left side view of the core 502 of the cylindrical switching unit 500. FIGS. 14B and 14C are provided to better illustrate the connections provided by the horizontal ducts 510 and 520, and the vertical ducts 530 and 540.

In the description provided above, it was assumed that the heating and cooling unit 100 would provide both heated air during a heating operation and cooled air during a cooling operation. In alternate embodiments, the heating and cooling unit 100 might only include a heater, or it might only include an air conditioning unit. For instance, if a building is located in a warm climate area, there would be no need for the building to include a heater. Instead, the building would only have an air conditioning unit. Likewise, if a building is located in a cool climate area, the building might only include a heater, and it would not have an air conditioning unit. Benefits of the above-described systems could also be obtained by buildings having only a heater or only an air conditioner.

If a building includes only a heater, the switching unit would be set into the heating mode when the heater is being operated to provide heated air into the rooms of the building. If, on a particular day, the outside temperature becomes unusually warm, it would be possible to set the switching unit into the cooling mode, and then run the system with just a fan to circulate air. Although the air provided into the rooms of the building would not be cooled by the heating and cooling unit 100, the air would still circulate. And the movement of cooler air at the bottom of each room towards the top of each room, resulting from the airflow caused when the switching unit is in the cooling mode, would still serve to better distribute the cool air in the rooms. Thus, some benefit would be provided by operating the system in the cooling mode, with just a fan running, even though no air conditioning unit is cooling the air passing through the heating and cooling unit 100.

Likewise, if a building only includes an air conditioning unit, the switching unit would be set into the cooling mode when the air conditioning unit is running. If a particular day is unusually cool, the switching unit could be switched to the heating mode, and the air could simply be circulated with a fan. Although no heater would heat the air passing through the heating and cooling unit 100, simply moving the air in the heating mode would serve to better distribute the warmer air at the tops of the rooms down towards the bottoms of each room. Thus, some benefit would be obtained from running the system in the heating mode with just a fan.

In view of the foregoing, the inventor believes that a system as described above can be beneficial even for buildings that have only a heater or only an air conditioning unit.

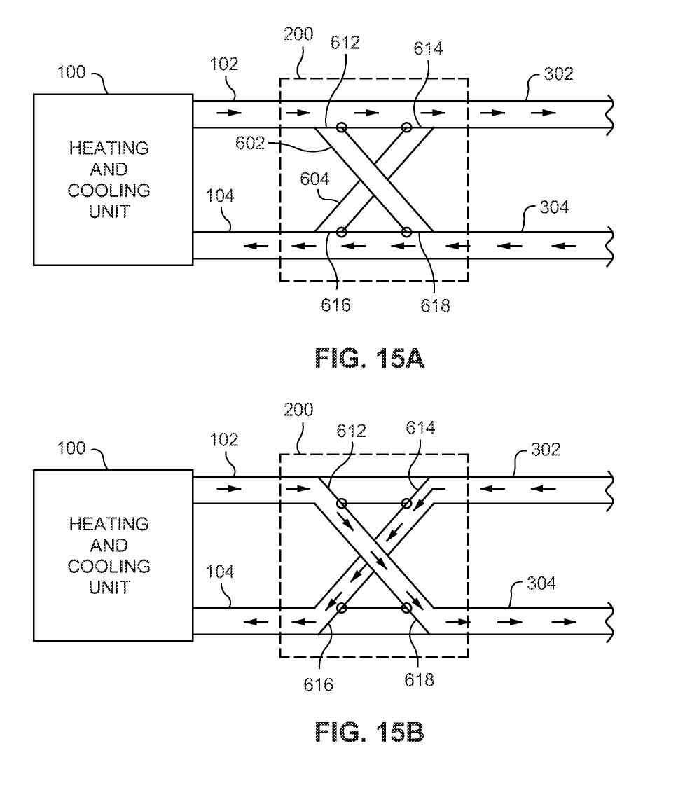

FIGS. 15A and 15B illustrate an alternate embodiment of the switching unit. In these drawing figures, the switching unit is illustrated with dashed line 200.

The switching unit includes two crossing ducts 602 and 604, both of which pass between the output duct 102 and the input duct 104 of the heating and cooling unit 100. Two movable damper flaps 612 and 618 are located at opposite ends of the first crossing duct 602. Likewise, two damper flaps 614 and 616 are located at opposite ends of the second crossing duct 604.

When the switching unit 200 is operating in the heating mode, as illustrated in FIG. 15A, the damper flaps 612, 614, 616 and 618 are in the positions illustrated in FIG. 15A. As a result, heated air from the heating and cooling unit 100 passes from the output duct 102 straight through to the duct 302 which is connected to vents in the upper portions of the rooms of a building. Likewise, the duct 304, which is connected to vents in lower portions of the rooms of a building, is directly connected to the input duct 104 to heating and cooling unit 100.

The switching unit 200 can be switched into a cooling mode, as illustrated in FIG. 15B, by moving the damper flaps to the positions illustrated in FIG. 15B. As a result, cool air leaving the heating and cooling unit 100 through the output duct 102 is routed to the duct 304 connected to vents in the lower portions of the rooms of a building. Likewise, the air being removed from the upper portions of the rooms through the duct 302 is coupled to the input duct 104 passing into the heating and cooling unit 100.

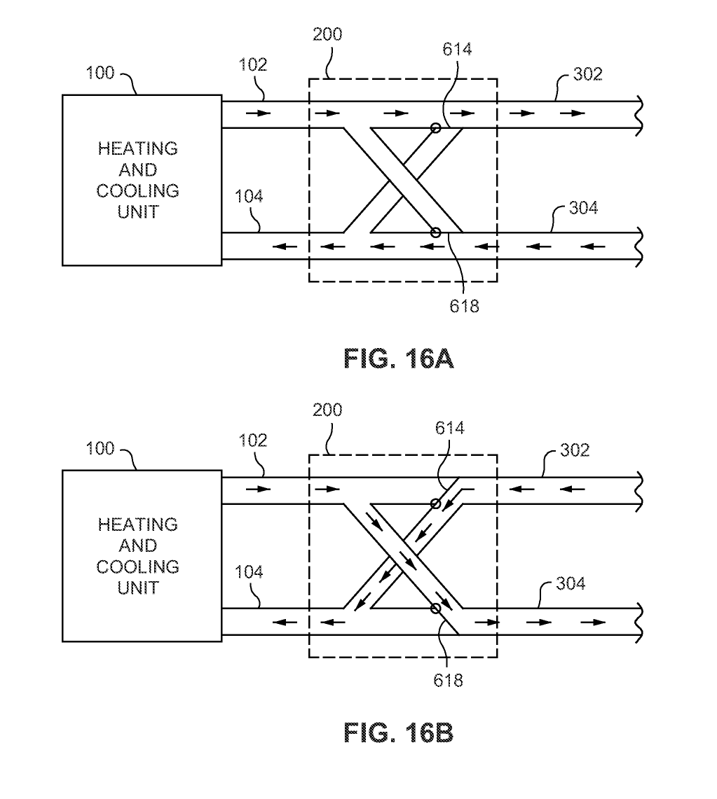

FIGS. 16A and 16B illustrate another alternate embodiment that is similar to the one shown FIGS. 15A and 15B. In this embodiment, only two of the damper flaps are provided. Specifically, the damper flap 614 and the damper flap 618 are included, but the remaining damper flaps are removed. FIG. 16A illustrates the alternate embodiment operating in a heating mode, and FIG. 16B illustrates the alternate embodiment operating in a cooling mode.

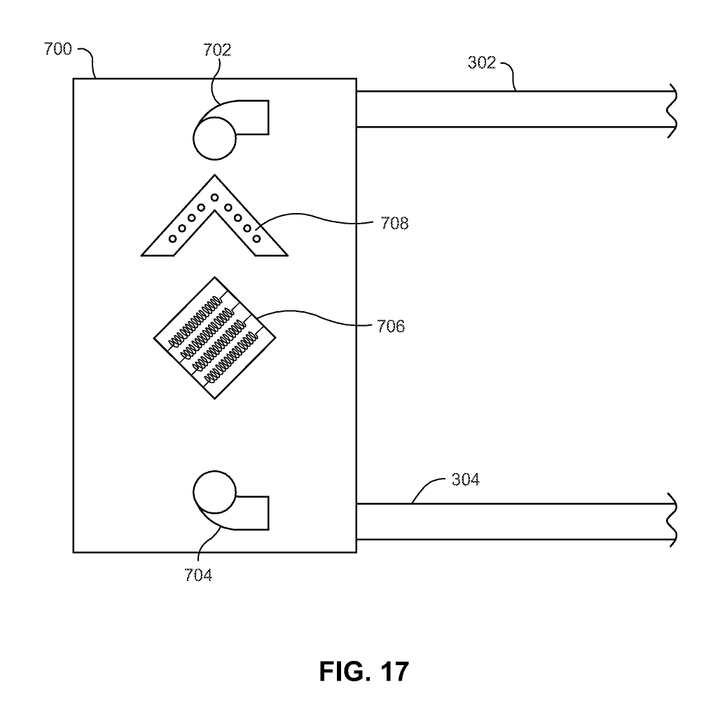

FIG. 17 illustrates yet another alternate embodiment of a heating and cooling system which does not require the use of a switching unit. In this embodiment, the heating and cooling unit 700 includes a first fan 702 and a second fan 704. Also included is a cooling core 708 and a heating core 706.

When the embodiment illustrated in FIG. 17 is to be operated in the heating mode, the first fan 702 will be activated to blow air into the duct 302 passing to the upper portions of each of the rooms of a building. The heating core 706 would be activated to heat the air which is being delivered into the upper portions of the room. Air returning from the rooms through the duct 304 connected to the lower portions of the rooms would then be received back into the lower portion of the heating and cooling unit 700.

When the system is operated in a cooling mode, the lower fan 704 would be activated. In addition, the cooling core 708 would cool air passing through the heating and cooling unit 700. As a result, cool air would be delivered to the lower portions of the rooms through the duct 304 connected to the lower portions of the rooms. Air removed from the upper portions of the rooms through the duct 302 would be delivered back into the upper portion of the heating and cooling unit 700. By providing two different fans 702 and 704, it is possible to reverse the flow direction of the air without the use of the separate switching unit.

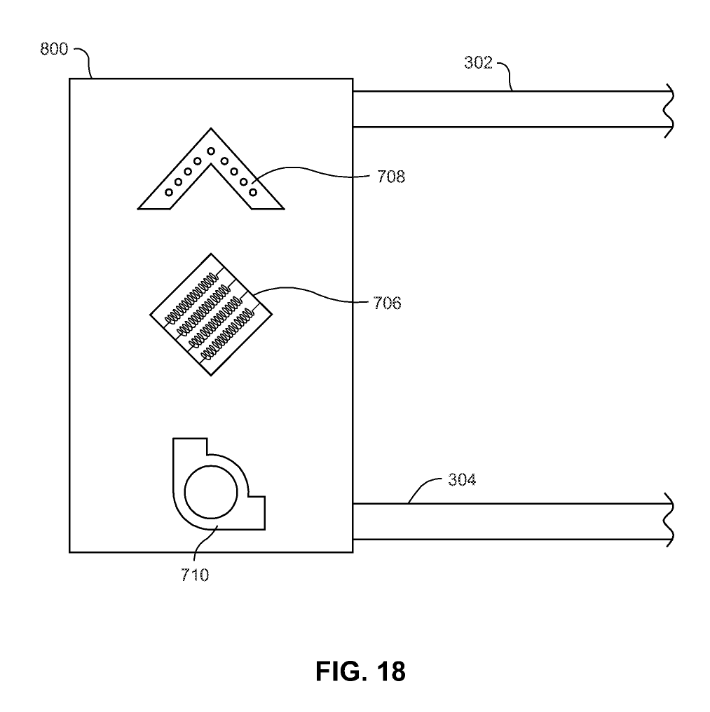

FIG. 18 illustrates yet another alternate embodiment which includes a bi-directional fan 710. This embodiment would operate in a fashion similar to that described above for the embodiment illustrated in FIG. 17. However, in this embodiment, the bi-directional fan 710 would be capable of reversing the air flow direction without the use of an additional separate fan unit.

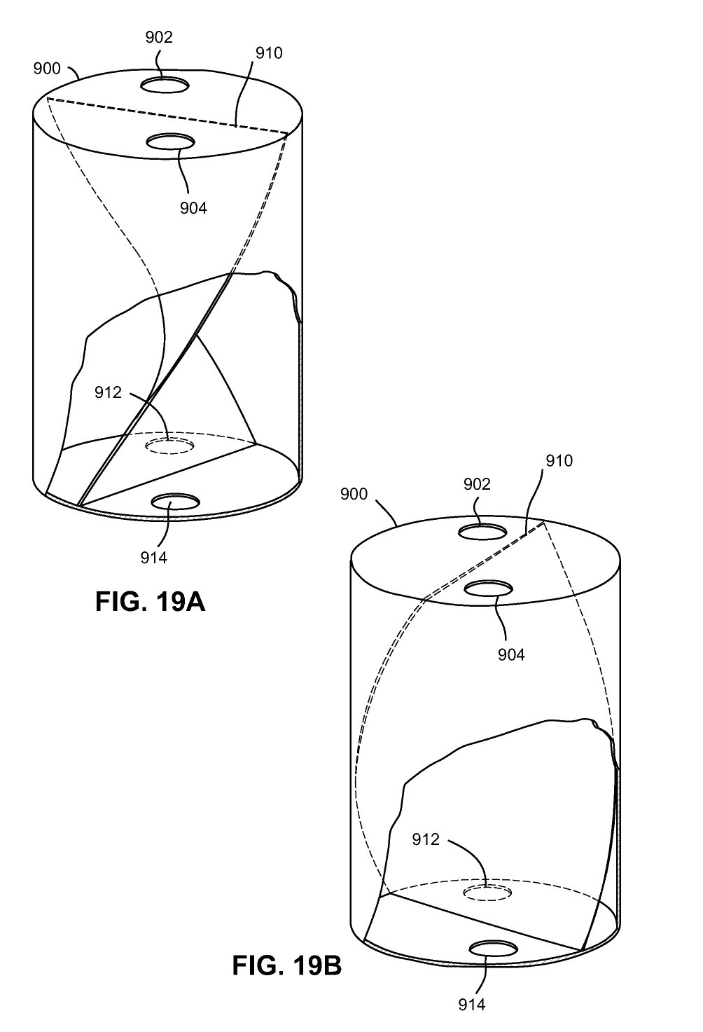

FIGS. 19A and 19B illustrate another alternate embodiment of a switching unit. In this embodiment, a helical-shaped switching plate 910 is rotationally mounted inside a cylindrical housing 900. The helical switching plate twists around 90° from the top of the cylindrical housing 900 to the bottom of the cylindrical housing 900. The helical switching plate 910 is itself capable of being rotated at least 90° between first and second positions.

The cylindrical housing 900 has an upper circular end cap and a lower circular end cap. Two apertures 902, 904 are formed on opposite sides of the upper end cap. Likewise, two apertures 912, 914 are formed on opposite sides of the lower end cap. Similar to the embodiments discussed above, ducts running to upper and lower vents in the rooms of a building would be attached to the apertures 912, 914 on the lower end cap, while ducts running to the inlet and outlet of the heating/cooling unit would be attached to the apertures 902, 904 of the upper end cap, or vice versa.

FIG. 19A shows the helical switching plate 910 in a first position. In this position, the helical switching plate couples the first aperture 902 on the upper end cap to the second aperture 914 on the lower end cap. Also, the second aperture 904 on the upper end cap is coupled to the first aperture 912 on the lower end cap. With the helical switching plate 910 in this position, the apertures in the upper and lower end caps could be connected to one another so as to deliver air from a heating/cooling unit to upper portions of the rooms of a building. Air would also be removed from the lower portions of the rooms of a building and delivered back to the heating/cooling unit.

FIG. 19B shows the helical switching plate in a second position. In this position, the helical switching plate couples the first aperture 902 on the upper end cap to the first aperture 912 on the lower end cap. Also, the second aperture 904 on the upper end cap is coupled to the second aperture 914 on the lower end cap. With the helical switching plate 910 in this position, the apertures in the upper and lower end caps could be connected to one another so as to deliver air from a heating/cooling unit to lower portions of the rooms of a building. Air would also be removed from the upper portions of the rooms of a building and delivered back to the heating/cooling unit.

Although the switching unit illustrated in FIGS. 19A and 19B has apertures in certain locations on the upper and lower end caps, in alternate embodiments, these locations could be varied while achieving the same or different aperture-to-aperture coupling effects. Also, the apertures could instead be placed on the upper and lower portions of the sidewall of the cylindrical aperture. In still other embodiments, some of the apertures could be located on the upper and/or lower end caps, while other apertures could be located on the cylindrical sidewall. Various considerations such as the mounting location of the switching unit could dictate where the apertures are best placed.

Moreover, in this embodiment, the helical switching plate has a 90° twist from the top to the bottom of the cylindrical housing. In alternate embodiments, the helical switching plate could have more or less of a twist from the top to the bottom of the housing.

Further, although not shown in the drawings, a motor or other power operated device could be provided to cause the helical switching plate to move between the first and second positions. In other embodiments, a handle coupled to the helical switching plate might protrude through either the cylindrical sidewall or the upper or lower end cap to allow a user to manually move the helical switching plate between the first and second positions.

Also, because the housing is cylindrical, the helical switching plate could rotate 90° backwards and 90° forwards to switch between the first and second positions. Or, in alternate embodiments, the helical switching plate could rotate 90° forwards to switch from the first position to the second position, and then 270° forward to switch from the second position back to the first position. Thus, the helical switching plate could be configured to always rotate in the same direction.

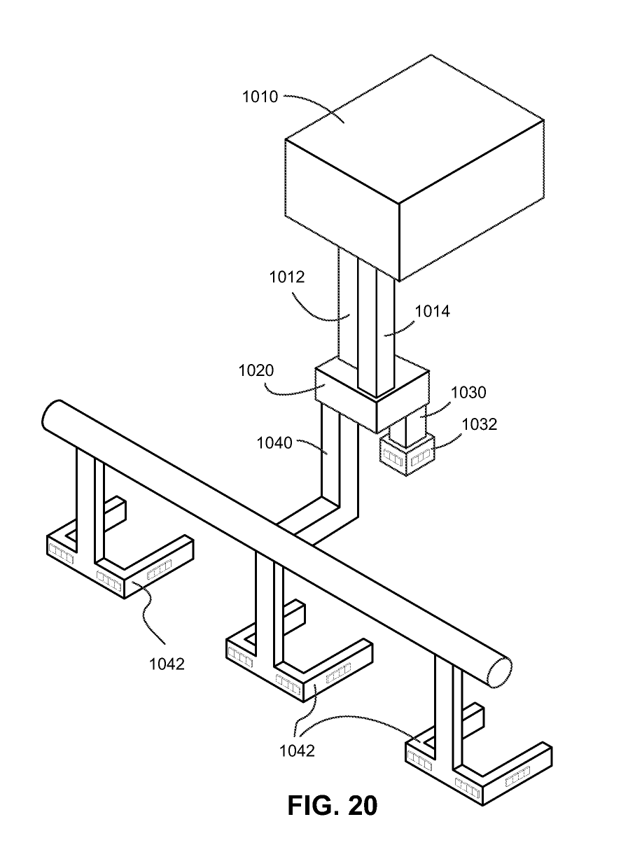

Switching units as described above can also be used in environmental control systems that are used in large buildings, such as warehouses, large warehouse-style retail stores, or simply in large retail establishments. The basic arrangement of the elements of one such environmental control system is illustrated in FIG. 20.

As shown in FIG. 20, a heating and air conditioning unit 1010 would be mounted on the top of a building. Both a “conditioned” air duct 1012 and a return air duct 1014 would extend down through the roof from the outdoor unit 1010 into the building. The two ducts would be coupled to a switching unit 1020. The switching unit could be any of the above-described embodiments, or alternate embodiments.

The switching unit 1020 is also coupled to an lower air duct 1040 and an upper air duct 1030. The lower air duct 1040 leads to a plurality of lower vent units 1042 which are located in the lower portion of the building. The upper air duct 1030 leads to at least one upper vent unit 1032 located in an upper portion of the building. In the embodiment illustrated in FIG. 20, there are three lower vent units 1042 coupled to the lower air duct 1040, and one upper vent unit 1032 coupled to the upper air duct 1030. However, in alternate embodiments, different numbers of the upper and lower vent units could be used, depending on the configuration of the building, and the heating and cooling needs.

The switching unit 1020 allows the interconnections between the conditioned air duct 1012 and the return air duct 1014 on the one hand, and the lower air duct 1040 and the upper air duct 1030 on the other hand, to be switched. Thus, when the exchanger unit is in heating configuration, the conditioned air duct 1012 would be coupled to the upper air duct 1030, and the return air duct 1014 would be coupled to the lower air duct 1040. When the exchanger unit is in a cooling configuration, the conditioned air duct 1012 would be coupled to the lower air duct 1040, and the return air duct 1014 would be coupled to the upper air duct 1030.

In a traditional large building, the ducts leading to the outdoor unit are connected to the vents units inside the building the same way all year round. However, when heating a building, greater overall efficiency can be obtained when the ducts and vents are coupled to each other in a first way as opposed to a second way. And when cooling the building, greater overall efficiency can be obtained when the ducts and vents are reverse connected. Thus, the provision of the switching unit 1020 allows the interconnections between the ducts and vents to be switched to the maximum efficiency configuration at all times. This results in a greater year-round efficiency for the building.

FIG. 20 illustrates a single outdoor heating and cooling unit 1010 that would be mounted on the roof of a building, and a single upper air duct and lower air duct. However, in a large building, multiple such outdoor units and associated ducting would likely be provided. Also, in individual embodiments, different arrangements of the upper and lower air ducts and vent units could be provided. For instance, multiple upper vent units may be provided instead of just one.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of configuring an environmental control system of a building, comprising:
installing a plurality of upper vents in upper portions of a building;
installing a plurality of lower vents in lower portions of the building;
coupling the plurality of upper vents to a first I/O port of a switching unit;
coupling the plurality of lower vents to a second I/O port of the switching unit;
coupling an inlet of the switching unit to an outlet of a heating and cooling unit that produces heated and cooled air;
coupling an outlet of the switching unit to an inlet of the heating and cooling unit;
wherein the switching unit is configured so that it can switch between a heating mode in which the inlet of the switching unit is coupled to the first I/O port and the outlet of the switching unit is coupled to the second I/O port, and a cooling mode in which the inlet of the switching unit is coupled to the second I/O port and the outlet of the switching unit is coupled to the first I/O port.

2. The method of claim 1, wherein the step of installing a plurality of upper vents comprises installing the plurality of upper vents at different locations in an upper portion of the building, and wherein all of the upper vents are coupled to the first I/O port of the switching unit.

3. The method of claim 2, wherein the step of installing a plurality of lower vents comprises installing a plurality of lower vents at different locations in a lower portion of the building, and wherein all of the lower vents are coupled to the second I/O port of the switching unit.

4. A switching unit for an environmental system of a building, comprising:
a first passageway that has a first end coupled to an inlet of the switching unit and a second end coupled to a first I/O port of the switching unit;
a second passageway that has a first end coupled to an outlet of the switching unit and a second end coupled to a second I/O port of the switching unit;
a first cross-connection duct that is coupled between the first end of the first passageway and the second end of the second passageway;
a second cross-connection duct that is coupled between the first end of the second passageway and the second end of the first passageway; and
a plurality of dampers, wherein a damper is located at each end of each of the first and second cross-connection ducts, and wherein the dampers are movable between first positions at which they seal the ends of the first and second cross-connection ducts and second positions at which they block airflow through middle portions of the first and second passageways.

5. The switching unit of claim 4, further comprising a switching mechanism that moves all of the dampers between the first and second positions.

6. The switching unit of claim 5, wherein the switching mechanism is power operated.

7. The switching unit of claim 5, wherein the switching mechanism comprises a manually operable lever or knob that is operatively coupled to at least one of the plurality of dampers.

8. The switching unit of claim 5, wherein the switching mechanism comprises a power operated unit that is configured to automatically move the dampers between the first and second positions depending on an operational state of a heating and cooling system incorporating the switching unit.

9. A switching unit for an environmental control system of a building, comprising:
pyramid shaped enclosure that includes a rectilinear base and four triangular-shaped sidewalls, wherein a base edge of each sidewall is joined to the base and wherein side edges of the each sidewall are joined to adjacent sidewalls;
an inlet opening into an interior of the enclosure;
an outlet opening into the interior of the enclosure;
at least one first I/O port opening into the interior of the enclosure;
at least one second I/O port opening into the interior of the enclosure; and
a triangular shaped switching plate that is rotatably mounted inside the enclosure, wherein the switching plate can be moved to a first operating position at which the switching plate operatively couples the inlet to the at least one first I/O port and the outlet to the at least one second I/O port, and wherein the switching plate can be moved to a second operating position at which the switching plate operatively couples the inlet to the at least one second I/O port and the outlet to the at least one first I/O port.

10. The switching unit of claim 9, further comprising a changeover unit that moves the switching plate between the first and second operating positions.

11. The switching unit of claim 10, wherein the changeover unit comprises a manually operable lever or knob that is operatively coupled to the switching plate.

12. The switching unit of claim 10, wherein the changeover unit comprises a power operated unit that is configured to automatically move the switching plate between the first and second operating positions depending on an operational state of an environmental control system incorporating the switching unit.

13. The switching unit of claim 9, wherein the inlet and the outlet are located on sidewalls of the pyramid shaped enclosure.

14. The switching unit of claim 9, wherein the inlet and the outlet are located on the base of the pyramid shaped enclosure.

15. A switching unit for an environmental control system of a building, comprising:
a cylindrical shaped enclosure;
an inlet located on an upper portion of a first side of the cylindrical shaped enclosure;
an outlet located on a lower portion of the first side of the cylindrical shaped enclosure;
a first I/O port located on an upper portion of a second side of the cylindrical shaped enclosure;
a second I/O port located on a lower portion of the second side of the cylindrical shaped enclosure; and
a cylindrical shaped ducting element that is rotatably mounted inside the cylindrical shaped enclosure, wherein passageways are formed through the ducting element, the passageways including:
a first passageway located in an upper portion of the ducting element, the first passageway extending from a first side of the ducting element to a second side of the ducting element,
a second passageway located in an lower portion of the ducting element, the second straight passageway extending from the first side of the ducting element to the second side of the ducting element,
a first cross-over passageway that extends from an upper portion of a third side of the ducting element to a lower portion of a fourth side of the ducting element, and
a second cross-over passageway that extends from a lower portion of the third side of the ducting element to an upper portion of the fourth side of the ducting element, wherein the ducting element can be rotated between a first operating position at which the first passageway couples the inlet to the first I/O port and the second passageway couples the outlet to the second I/O port and a second operating position at which the first cross-over passageway couples the inlet to the second I/O port and the second cross-over passageway couples the outlet to the first I/O port.

16. The switching unit of claim 15, wherein the second side of the ducting element is located 180° around from the first side of the ducting element, and wherein the third side of the ducting element is located 180° around from the fourth side of the ducting element.

17. The switching unit of claim 16, wherein the first side of the ducting element is located 90° around from the third side of the ducting element.

18. A switching unit for an environmental control system of a building, comprising:
a cylindrical shaped enclosure;
an inlet located on a first side of a first end the cylindrical enclosure;
an outlet located on a second side of the first end of the cylindrical enclosure;
a first I/O port located on a first side of a second end of the cylindrical enclosure;
a second I/O port located on a second side of the second end of the cylindrical enclosure; and
a helical shaped switch element that is rotatably mounted inside the cylindrical enclosure, wherein side edges of the helical shaped switch element seal against inner surfaces of the cylindrical enclosure, and wherein the helical shaped switch element is movable between a first operating position at which the inlet is operatively coupled to the first I/O port and the outlet is operatively coupled to the second I/O port, and a second operating position at which the inlet is operatively coupled to the second I/O port and the outlet is operatively coupled to the first I/O port.

19. The switching unit of claim 18, wherein a first end of the helical shaped switch element is offset from a second end of the helical shaped switch element by 90°.

20. The switching unit of claim 18, wherein the inlet and outlet are located on a first circular shaped end wall of the cylindrical shaped enclosure, and wherein the first I/O port and the second I/O port are located on a second circular shaped end wall of the cylindrical shaped enclosure.
